(19) United States
(12) Patent Application Publication
(10) Pub. No.: US 2012/0061967 A1
(43) Pub. Date: Mar. 15, 2012

(54) OCEAN WATER RUN AND VERTICAL DROP IS GREEN POWER GENERATION

(76) Inventors: Srinivas Bhaskar Chaganti, Secunderabad (IN); C. Bala, Secunderabad (IN)

(21) Appl. No.: 13/321,578

(22) PCT Filed: Apr. 22, 2010
(86) PCT No.: PCT/IN2010/000251

§ 371 Date: Nov. 21, 2011

(30) Foreign Application Priority Data
May 24, 2009 (IN) 385/CHE/2009

(51) Int. Cl. F03B 13/10; F03B 17/04

(52) U.S. Cl. 290/52; 415/916

(57) ABSTRACT

This invention is developed using all the laws of hydraulics and fluid dynamics by digging a tunnel, placing a pipe, etc in the earth surrounding the water body at various levels at least starting from the surface of the water body and going to the very bottom of the water bed in various geometrical figures, angles and degrees suitable for an individual project and individual site and individual generation requirements any where in the world for the water to come out of the water body either from the bottom, below the bottom of the water bed and projecting into the water body or from the sides surrounding the water body and run into the facility from the inlet and various inlets which is constructed below the main level of the water body or mean sea level or main water body level on the earth and required in the water body also so that the various turbine-generators of various capacities, shapes, designs, available in the global markets are erected in a cascading manner or any other system designed for the generation of electricity using various heads and a stable water flow and water velocity in the water ways, The water coming out of the facility with the help of difference in the hydro static pressure etc starting from the water body which is transferred into the tunnel, facility, method etc and the same hydro static pressure is moving in the entire tunnel, facility, system, method etc making the water run and spin the turbines and water is removed with the help of the outlet and multiple outlets exposed to the surface of the earth and open to sky so that the water will flow in the canal which is above the mean sea level discharging the pressure created in the tunnel, facility, method etc by pumps and reaching the water body once again.

This facility will be in a pipe, tunnel, or half tunnel half open or full tunnel or full open or in the beginning tunnel and ending tunnel and in the middle open. This facility will work in a concealed area like pipes, tunnels, open area like canals, channels or open waterways, in the water body, out of the water body, in the earth and out of the earth for the generation of electricity.

Anti corrosive technology is used to safe guard the entire invention, facility, method etc.

Head varies generation varies. Means for regulating the flow of water are provided including at least one water pump to expel the water from the bottom to the top and above the mean sea level into a canal to join the water body, with the combination of various engineering department using industrial hydraulics, water hydraulics, hydro ram and pneumatic power for the electrical generation and for the water to flow into the inlets and go out of the outlets.

### METHOD

This innovation and method is for the generation of hydro electricity is for individual requirements at individual places tailor made in every country by using all the earth and all water body on the planet by creating enough space and structures in the land, on the land, above the land in the water body and out of the water body, can create space, structures for inter connected islands, valleys, pits etc and so on from the water body by filling the required area on the water body floor by sand, rock, granite, concrete ruble etc and so on to create the exact level differences for the water to run from the top to bottom into every single individual turbine-generator and to erect the power stations etc using all the laws existing for hydro power generation the application is water from any water body either rain water, salt water etc.

By using the laws of hydraulics and fluid dynamics with the basic principles and with the application of regularly applied fundamental hydraulic engineering principles combined with generation methodology for the mathematical analysis of the movement of fluids in fluid mechanics to achieve practical engineering solutions. The energy potential is proportional to the amount of water flow through a turbine generator are interrelated to the head, flow, water drop, water velocity in the water ways, system, method, technology, a type of hydro power facility, in combination with a hybrid and a non hybrid etc and so on which are used in the innovation as described herein will be in the earth, on the earth, above the earth, in the water body, out of the water body etc and so on.

Also taking advantage of the level difference created naturally where the water body is a higher level and the land is at a much lower level. Fill a part of the water body with sand and gravel creates an artificial island and creates pits and valleys and level adjusted for hydro electrical generation and be at least a trench, creator, pits, underground excavations valleys, mufti floor constructions, in the Earth, tunnel or pipe tube, intakes, canal, channel, ducts, spillways, weirs, reservoirs, dams etc and so on or any other types of systems, methods, innovations, facilities, water ways and water bodies where in water or a fluid can flow, run, fall or be stored, and it can always be substituted by any other type or type of water bodies, systems, innovations, methods, hybrid, design, etc and so on and no limitations as to any variety of water ways, systems, methods, designs, innovations, hybrid etc and so on available to the scientific innovative and engineering world and the design describe herein along with the desired specification and dimensions herein in the method and in the innovation will be used for all types of water bodies, systems, methods, designs, facilities, hybrid etc and so on with Multiple combinations of different types of innovations, systems methods, designs, facilities, hybrid etc and so on must be read in this specification for the purposes of hydro power generation and for all other bi products of water etc and so on. The dimensions and specifications described herein can be modified, rectified, improved, corrected etc and so on for any system, method, facility, civil structures, design, machinery etc and so on the entire innovation is with in the range can be modified any time for generation of hydro electricity from few watts to any number of megawatts, small to big generations.

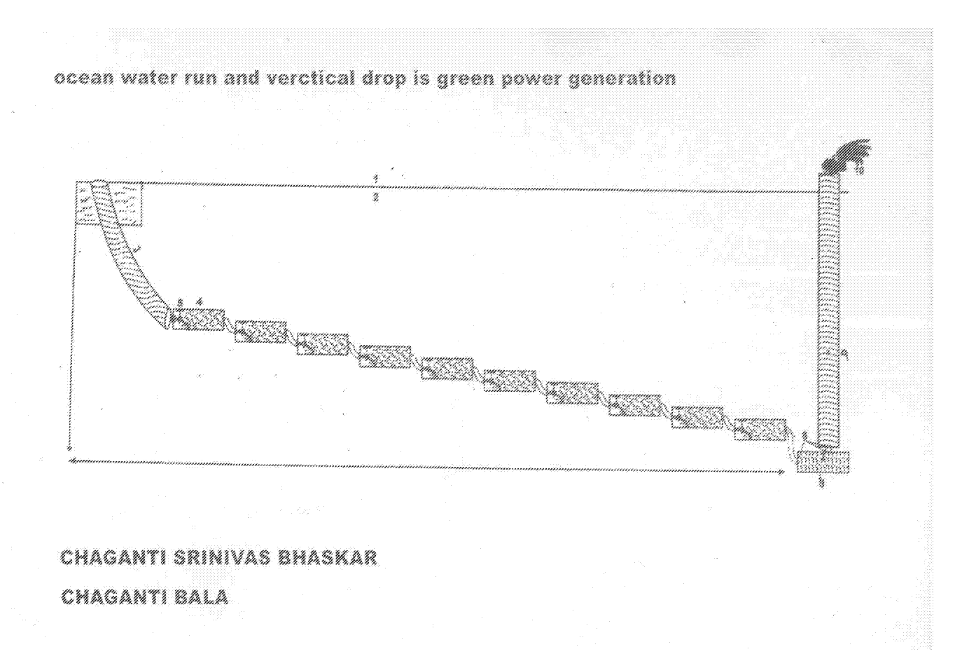

FIG. 1 surface of the ocean Msl

FIG. 2 surface of the earth,

FIG. 3 Inlet water way below Msl

FIG. 4 cavity below Msl

FIG. 5 valves and gate

FIG. 6 turbine

FIG. 7 main outlet reservoir

FIG. 8 at a time only one turbine impinging water is let inside the outlet reservoir to drain the water out above Msl

FIG. 9 main outlet tank FIG. 10 water pump cum hydraulic system to expel water above Msl into canal.

Head varies generation varies and by this the entire innovation will be changed must be read in the specification jointly and severally using various methods, designs, facilities, combinations, technologies, additions, modifications, manipulations, improvements, corrections, innovations, etc and so on with out any limitations and so on for the entire innovations, structure, methods and systems, facilities, hybrid etc in the innovation for the mufti purpose of hydro electrical generation and for all the bi-products of water etc and so on.

When demand is high, valves in the system will permit water to run through the turbine-generator in the innovation at a rate high as 9000 cubic meters or more in a vertical drop per each and every single second/minute through each and every individual turbine-generator in this innovation.

The innovation, system, method, etc consists enough space for each and every individual items like a number of reservoirs called individual dams, reservoirs, chambers and layers etc at various levels on all and every individual steps in the innovation having multistory layers, chambers, compartments etc one above the other and one below the other for various multiple uses in a scientific innovative way with the state of the art and technology available in the engineering world.

In a preferred embodiment the invention uses the earth surface adjacent to the shore of the water body as the dam and the water body as the reservoir for water. Head varies generation varies and there by this the entire structure, entire innovation, system, method, hybrid, facility etc and so on for the configuration, construction dimensions, water flow, specification, cost, machinery etc and so no and every thing from a to z changes jointly and severally what so ever using every technology, method, system, hybrid, facility etc and so on available for the entire system for small and big generations individually and independently.

In this invention the raw material used is water from any water body i.e. ocean water, sea water, river water, etc, and by the run of the water supplied through man made channels like the canal etc and so on and this canal is connected to a spillway and this spillway is connected to the main supply tunnel with multiple outlets discharging water into a series of dams, reservoirs or structures for the water to run the hydro turbine-generator to generate hydro electricity in individual dams constructed in step wise starting from the surface of the earth and going deep down into the earth and on the earth and above the earth too by creating artificial mountains, islands etc and so on and in rows constructed horizontally or in any other design in step wise at least 12 inches to 100 meters deep is the depth for each step, width of each sep will be 12 inches to 1000 meters, at least 100 meters to 30 kilometers or more in length in the earth slantingly horizontally down stepping down like the stair case steps model.

The earth is dug and excavated and steps are formed from top to bottom and bottom to the top like the staircase design mirror type. One step starts where the other step ends deep in the earth at least the total structure from top to bottom and bottom to top having enough space for different reservoirs, compartments, chambers, and layers constructed at different heights and horizontal small dams in rows constructed on each and every individual single step.

The energy potential is proportional to the amount of the water flow, water run, water drop, water velocity etc for each and every individual single turbine-generator in a single individual dam. Each dam will release at least 6000 liters to maximum 6000000 liters water per every individual single second/minute in vertical drop and the water is released like a jet with full pressure per every individual second to spin every individual turbine-generator erected vertically at least from 1 KW to maximum 1000 MW capacity each and the MW can be extended or reduced further depending upon the generation capacity and the requirements at independent places.

All dams, reservoirs etc constructed on each individual steps in rows will be horizontally placed or any design suitable to the innovation, system, method, hybrid, etc and will hold at least 6000 liters to maximum 1800000000 liters or more.

The water from the very first dams constructed on the very first top step and in the very top row will flow down from step to step.

Each step will have number of dams, reservoirs, chambers, layers, having space, height etc with same dimensions and same capacity turbine-generator and the water will be flowing and running, falling in a vertical drop, rotating and circulating non stop is rotated into all other individual dams situated one below the other like water flowing and running down the hill through all the steps from top to bottom going down one below the other like a staircase.

Water passing through the final step passing through the turbine-generator for the final time the impinging water will finally fall into the final outlet reservoir this reservoir will raise from bottom to the top surface of the earth in step wise step up like going up the staircase method so that the water will rise slowly and the steps will accommodate the weight of the water.

Water in this outlet reservoir will rise from the very bottom and to the top of the surface at main sea level by only pumps.

At the main sea level the water is sent into different small water compartments of 10 meters length×10 meters width×10 meters depth and from these compartments water is pumped out using water pumps in combination with industrial hydraulics, water hydraulics, pneumatic power etc and so on.

With at least few millimeters head to maximum 10000 meters head and 1000 ml to 6000000 lakh liters water released in a vertical drop per every single individual second passing through a single individual at least 1 KW to maximum 1000 megawatts hydro turbine-generator erected vertically. The generated electricity is connected to the grid to supply.

Water is having potential energy and this potential energy is converted into kinetic energy is converted into mechanical energy and by the run of the ocean water and vertical drop into electrical energy.

A series of units can be erected and constructed along the entire coasts and in the land wherever there is sea, ocean, or water body and land to generate hydro electrical generation etc using this innovation for the entire world for the development of mankind. The system invented is for multiple utilities and for various multiple functions for the system or method to operate successfully in any part of the world and with any water any water body available on the earth to generate hydro electricity and to produce other bi products of water from water body.

To make the water enter and exit and to erect the electrical generation machineries and the civil structures in the entire system will be according to the requirements for a specific site independently. Head varies generation varies.

The inlet and the multiple inlets, the outlet and the multiple outlets and the entire interconnected passageways design and the design of the super structures and elevation and dimensions and specifications of the entire system, method, facility etc can be modified any time according to the requirements for any site and the inlet and the outlet can be exposed at least much before the water body in the ground for the water to enter into the inlet with the help of water ways i.e. canal, pipe, etc and with the help of multiple inlets and to drain out the water from the system from outlet and multiple outlets and collected in a final outlet reservoir and lifted up step by step design with multiple options existing in the scientific technical engineering world and with the help of the competent authorities and professionals in there respective fields with suggestions to use devices like pumps, industrial hydraulics, water hydraulics pneumatic power, capillary system, etc suitable to the requirements at the individual site and to send the water back to the ocean, from above the mean sea level. Which ever is economical and time saving in the interest and success of the project by using various methods, designs, combinations, technologies, additions, modifications, manipulations, etc and so on for the entire structures, methods and systems, hybrid, facility etc in the innovation depending upon the terrain, ground condition, soil condition, variability aspect using various methods which are always open with freedom and without restrictions like pumps, hydraulic laws for the water to enter and to exit.

The entire innovation i.e. The system, method, hybrid etc and so on will be custom designed and built and insured as per individual requirements of national and international standards and will be tested in the laboratory before the erection and with the approvals of the various competent authorities of various departments as a team. Anti-corrosive technology will be used to protect the structures and the machinery and wherever required and various safety measures to protect the marine life and for the entire innovation, system, method, etc and so on including the workers will be implanted and implemented. Discharge from canal will be far away from the ocean and electricity spent on the pumps either coming from the system, method, siphon, hybrid, will be directly or indirectly or can be drawn from the grid for lifting this water from the bottom to the surface of the earth and above mean sea level.

This Classification by facility or usage is for under the earth usage only because above the earth we all know every thing and every human development is visible. Pumps consume a large portion of the generated electricity in this human world for pumping activities just for the human survival, so we can take back some energy from what we give to the pump sector because energy is released by the pumps in the form of kinetic energy and hard pressure in the form of running water inside the world of pipes. Action and reaction are equal and opposite, is a useful law for this innovation or to support our idea. What you give you can always take back like the pumps use there force to drive the water inside the pipes for long distances so there is hard pressure developed inside the pipe all the while the pumps use there force for pushing water inside the limited space available inside the limited pipe diameter there by generating kinetic energy inside the pipe and if a turbine is placed inside the pipe the water flowing by the pressure of pumps can rotate the turbine blades placed inside the flowing water and with out altering the flow velocity inside the pipe will generate electricity is our innovation where ever there is kinetic energy there is electricity we just have to use a way to extract this energy for the support of the grid for peak load requirements.

| Rough classification | Detailed classification | Usage or facilities |
|---|---|---|
| City industrial relation | Life “Human” | Basement “Earth” |
| “Human world in the earth | | Underground storing facilities |
| and above the earth uses | Culture and Education | Music hall |
| Pipes every where for the | | Cultural building |
| survival, there by this major | | Library |
| area is having big kinetic | | Leisure facility |
| energy running nonstop | Commerce | Underground shopping mall |
| inside pipes all the year can | | Underground car parking |
| be used for energy | | Sports facility |
| development like the hydro | Industry | Office underground |
| power generation inside the | | Various underground factories |
| Pipe” | Research and development | No gravity laboratory |
| | | Underground biotechnology facilities |
| | | Observation and investigation facilities |
| | Supply and processing | Power transmission and gas facilities |
| | | related to upper and lower water service |
| | | Industrial waste disposal |
| | | Garbage collection and garbage processing |
| | | Underground substation |
| | | Heat supply facilities |
| | Environmental and disaster | Disaster prevention shelter |
| | | Underground River |
| | | Underground dam and pound |
| Distribution transport | Traffic | Facilities related to traffic |
| relation | | Underground station |
| | Distribution and storing | Underground warehouse |
| | | Distribution tunnel |
| | Information and communication | Information computer center |
| | | Communication facilities |
| Energy relation | Fuel storing to support the | Nuclear fuel storing facilities |
| | energy world | Oil storing facilities |
| | | Gas storing facilities |
| | | Energy storing |
| | | Super conducting electric power energy |
| | | storing |
| | | Compressed air energy storing |
| | | Electric power generation: hybrid and non |
| | | hybrid combinations using |
| | | Nuclear power plant |
| | | Thermoelectric power plant |
| | | Hydroelectric power plant |
| | | Solar dam power plant |
| | | Wind power plant |
| | | Kite energy |

We claim:

1. METHOD
1. Those of skill in the art will appreciate This Method or innovation using all hydraulic and fluid dynamic laws for electrical generation by capturing the every day flowing water, releasing kinetic energy inside an object called pipe as the water flows and flows and flows in this object called pipe from one area to another area in the man made network of interconnected water runways called as inter connected net work of pipe lines. There by the flowing water having kinetic energy will be rotating and revolving many individual turbine arranged in rows or series in the path of flowing water having the required intervals fixed in between the two individual turbines fixed inside the pipe in the path of flowing water in the mufti network of pipes, for all the individual turbine blades to rotate to generate electricity and still the water will be flowing from one pipe to another pipe for long distances with out much change in the kinetic energy and still keeps on releasing kinetic energy all the way while flowing in different gradient angles and degrees in man made world of pipes till the flowing water reaches its destiny of usage, to achieve this phenomena this method will use an external pressure or application suitable for the desired flow rate and velocity of the running water inside the net work of pipes by using pumps or by the application of industrial hydraulics used for pumping water for long distances inside the man made object called the pipe for the generation of electricity or placing a specific object like the pipe or any man made objects like the pipe in the path of naturally flowing water by the law of gravity from a higher level to a lower level with out using any external pressure inside in any man made specific given objects or areas of usage and by the application of hydro power generation laws in this specific object or area for generating grid connectivity hydro power generation is achieved by fixing of the suitable required machinery only inside this specified pin point man made object or the exact area used for hydro power generation is involved in this innovation. By taking the specified object or area of power generation for consideration will be the object called The pipe, so power generation in this object will be called in pipe hydro power generation or The Tunnel, will be in tunnel hydro power generation or using any man made structures for hydro power generation designed by using any geometrical angles with the union and working combination with man made multi level hydraulic electrical generation power plant system there by the electricity is generated only inside this man made structures. This innovation is achieved by the application of all hydro power generation laws applied only inside the useable man made objects doing good for the innovation is the pipe or tunnel or any man made structures are desired by this innovation for hydro power generation using any water body, for example: like using the application of hydropower generation laws only inside the area called dam or run of the river or pump storage system, and for all these different applications the raw material is only water and machinery used is generator-turbine to generate electricity so just as the specified area called the dam is used for hydro power generation, This innovations application of hydropower generation laws are also implemented and used just inside this given specified area called “in the pipe” or the object of specific involving area using in this innovation for generation of hydro power is only in the Pipe or in the tunnel or any man made structures union with man made multi level hydraulic electrical generation innovation with the application and by the involvement of the cascading concept design to fulfill the desire of innovation by getting a clear picture of the technology used in this method for the generation of electricity here in from the following detailed elaboration explained in the continuation paragraphs below to explain the method in detail point by point, by it will be apparent to those skilled in the art that other changes in form and detail may be made therein without departing from the spirit and scope of the invention.
2. Those of skill in the art will appreciate for doing hydro power generation with the power of flowing water inside the pipe. Hydro power generation “in the pipe” is achieved by the application of all hydro power generation laws running just inside the pipe or doing hydro power generation only inside the pipe or Tunnel hydro power generation is achieved by the application of all hydro power generation laws just inside the tunnel or doing hydro power generation only inside the tunnel or Any man made structure hydro power generation is achieved by the application of all hydro power generation laws only just inside any man made structure or doing hydro power generation only inside the man made structures there by the concept of innovation in these following above specified and confirmed pin point specified areas are only used individually or in combination with each other for power generation by it will be apparent to those skilled in the art that other changes in form and detail may be made therein without departing from the spirit and scope of the invention.
3. Those of skill in the art will appreciate “Where there is head or kinetic energy there is electricity” and this innovation is for the generation of electricity by applying all the appropriate hydro power generation laws, machinery, technology, safety measures and using all other important procedures used herein in the innovation to design hybrid and non hybrid power generation power plants in working combination by using different forms of raw material used for power generation described herein by the application of any substance or raw materials used for generation of electricity or for any type of power generation power plant raw material usages to generate grid connective electricity for the support of the peak load requirements using the object called Pipe, or digging a tunnel or constructing any Man made structures, there by it will be apparent to those skilled in the art that other changes in form and detail may be made therein without departing from the spirit and scope of the invention.
4. Those of skill in the art will appreciate In the use of hydro power generation sector like application of water from natural water body or man made water body or any water body either using salt water or using rain fed water or using sewerage water or using municipal drinking water or using canal water or using industrial waste water or using any water, flowing inside the world of pipes or net work of pipes, tunnel or inter connected tunnels or into any man made channels and man made structures placed under the earth or placed with the surface of the earth or placed above the earth or top of the earth or will be placed above the mean sea level or below the mean sea level or with the mean sea level, or in the working combination of the three different mean sea levels of areas existing on the planet or placed inside the water body or on the surface of the water body or above the water body or in any of the above described interrelated combinations and areas is used for designing of hybrid and non hybrid cascading hydro power generation power plants it will be apparent to those skilled in the art that other changes in form and detail may be made therein without departing from the spirit and scope of the invention.
5. Those of skill in the art will appreciate The innovation using different angles, shapes, degree available in the working combination and union of engineering, architectural and geometrical worlds to design for the placement of every individual power generation power plants at individual sites using objects like the pipe, digging tunnel, construction of any man made structures and using all other important useful machinery taken into consideration are used for power generation like the generator-turbine, water flow pattern inside the turbine blades to fit inside the area of application by using pipes, tunnels any man made structure or in word the project itself at every individual sites all over the globe by using of the kinetic energy and hard pressure developed inside the pipe, tunnel, and man made structures for the water or fluid to store, flow, run, fall, or vice versa and rotate inside the area of application called the pipe, “small pipe, long pipe, big pipe or any thing defined as pipe or in the world of pipes having any shape, dimension etc for the water to enter from the inlet and run inside the body of the pipe and exit from the outlet of the pipe” pipe, tunnel, any man made structures it will be apparent to those skilled in the art that other changes in form and detail may be made therein without departing from the spirit and scope of the invention.
6. Those of skill in the art will appreciate The innovation for designing a independent hydro power project for a individual area like the placing of the pipe, digging tunnel, constructing any man made structure for the project implementation will use different angles, shapes, degree available in the working combination and union of engineering, architectural and geometrical worlds to design for the placement of the electrical generation machinery in harmony with in the space available inside the pipe, tunnel, any man made structure to match the arrangement of any water flow pattern for the turbine to rotate in a specified angle, for the turbine blades to rotate more efficiently for the turbine tail release to keep on flowing inside the inter connected pipes and with out disturbing the kinetic energy and hard pressure available in the flow within the net work of interconnected pipe lines so that the cascading arrangement of turbines arranged in rows, series or in any other design in the entire length of the inter connected pipe lines network will keep on rotating for continuous uninterrupted power generation supply to support the grid all the year and simultaneously supplying water to support for various activities of the human needs, Those of skill in the art will appreciate the turbine blades will be specially designed for the angle required when touching the flowing water running inside the pipe because the generator-turbine connected with the shaft and shaft connected to the turbine blades placed in the path of the flowing water, running water or falling water suitable for the angle of impingement of the water impinging the turbine and rotation of the water pressure head inside the turbine blades there by the turbine blades are designed to absorb all the kinetic pressure of the running water in that exact specified angle to rotate and spin the turbine blades arranged in path of the water runway so that the water flow should continue inside with the same velocity to spread kinetic energy equally in all the pipes, tunnel or any man made structure will be used for the generation of electricity to support the peak load requirements of the grid in any country, it will be apparent to those skilled in the art that other changes in form and detail may be made therein without departing from the spirit and scope of the invention.
7. Those of skill in the art will appreciate In the innovation diagram submitted here in Inlet of the pipe, tunnel, any man made structure connected to the water body or inside the water body or with the water body for the inlet water way to run inside the bifurcated or divided multi layered inter connected network of pipes using multiple inlets and multiple outlets spread out to serve different activities over a wide area of usages in the human world or there is no division of the inlet there by the innovation is comprising at least one inlet connected directly inside the water body and with the water body for the inlet water way water to store, flow, run and fall in the pipe or vice versa in every net work of pipes, tunnel or any man made structure, using the power house on upper layer which is dry to generate electricity by using generator connected to the turbine and lower layer for water runways for the water to flow and run on the water runway in which the turbine and the turbine blades connected to the shaft are placed in the path of the flowing water or running water or falling water to spin the shaft connected to the generator to generate the electricity there by the generated electricity is fed into a substation for transmitting this electricity from the substation to the grid or to generate grid connective electricity, it will be apparent to those skilled in the art that other changes in form and detail may be made therein without departing from the spirit and scope of the invention and Those of skill in the art will appreciate that absolute and relative dimensions are not discussed in the diagram submitted and are not to scale, as the diagram is for general structural comparison purposes only explaining the innovation because head varies the entire diagram design varies.
8. Those of skill in the art will appreciate Every individual pipe, tunnel, any man made structure will have one outlet situated at the far end of pipe, tunnel, any man made structure for the water to exit from the outlet will be at a much, lower level in slantingly sloppily down arrangement or in any other arrangement than the inlet connected to the water body for the turbine tail release to flow out into a tail pond or flow out into the water body naturally like the river, pond, reservoir or with the help of the pumps pump the water collected inside the tail pond back into the water body once again it will be apparent to those skilled in the art that other changes in form and detail may be made therein without departing from the spirit and scope of the invention.
9. Those of skill in the art will appreciate Every individual pipe, tunnel, any man made structure will have one outlet situated at the far end of pipe, tunnel, any man made structure for the water to exit from the outlet will be at a much, lower level in slantingly sloppily down arrangement or in any other arrangement than the inlet connected to the water body for the turbine tail release to flow out into or flow directly inside the other multiple inter connected cascading net work of pipeline or inter connected water runways connected with the far end of the pipe outlet for the hundreds of gallons of water per second or liters of water per second or cubic meters of water released inside the pipe per every second per minute to flow and run continuously inside the inter connected water runways every day through out the year helping in power generation and for other human uses too, it will be apparent to those skilled in the art that other changes in form and detail may be made therein without departing from the spirit and scope of the invention.
10. Those of skill in the art will appreciate With the union of working combination of using the lift irrigation system pattern working laws by using pumps to pump water inside the network of interconnected pipelines or using the natural flow by the law of gravity or in combination of both for placing the pipes with the required amount of gradient for the water to flow down from a higher level from the natural water body or man made water body or any water body to a lower level away from the water body or far away from the water body by the law of gravity so that The pipe outlet discharge or pipe outlet released flowing water, running water, falling water is connected to flow inside the wide net work of multiple interconnected water runways for the water or fluid running inside the interconnected pipe lines net work of a individual area covering millions of square miles or hundreds of kilometers for a given area like the city, town or village or where ever the human dwellings are established on this globe for the generation of electricity, it will be apparent to those skilled in the art that other changes in form and detail may be made therein without departing from the spirit and scope of the invention
11. Those of skill in the art will appreciate By placing a turbine or multiple turbines in rows or series or one after another or in cascading arrangements or in any required arrangement for the generator connected to turbine placed at specified intervals inside the pipe, tunnel, man made structures for generating electricity in the mufti network of inter connected pipe lines net work placed under the ground or with the surface of the ground or above the ground or in the combination of the above described three different ground level placements of the pipes will be used for supply of municipal drinking water or water pumping into irrigation supply pipe line network for irrigation and farming or to pump out the sewerage water into supply pipe line network connected with water treatment plants or to pump out the industrial waste water into pipe line network connected to water treatment plants or any running water inside the world of pipe or pipes or tunnels and man made structures, is designed for individual and tailor made projects for a given specified human dwelling area or to fulfill individually power generation requirement all over the globe for every country's independent power requirements and consumption using independent designs, it will be apparent to those skilled in the art that other changes in form and detail may be made therein without departing from the spirit and scope of the invention.
12. Those of skill in the art will appreciate This innovation is revolving in this concept called “head varies the generation varies according to the diameter in the pipe, tunnel, any man made structures” available there by the innovation design and every other things involved with the project will change in every individual power generation power plant for the invention using pipe, tunnel, any man made structure, it will be apparent to those skilled in the art that other changes in form and detail may be made therein without departing from the spirit and scope of the invention.
13. Those of skill in the art will appreciate The pipes or the interconnected net work of pipe lines will have kinetic energy and hard pressure all the year round where there is kinetic energy for human use there will be generation of electricity for the development of the human use by using any turbine or types of turbines and turbine blades connected to the shaft connected to the generator placed in the path of the kinetic energy example will be flowing water or wind or air or any other matter or raw material having kinetic energy there by head varies generation varies should be read in this innovation using various diameter and different lengths of pipes are used to support for different water activities for generating different kinetic energy outputs for different electrical generation concepts for the support of industry and human usage it will be apparent to those skilled in the art that other changes in form and detail may be made therein without departing from the spirit and scope of the invention.
14. Those of skill in the art will appreciate By placing a suitable turbine connected to the generator or dynamo, or baby micro Pico turbines or a suitable machine from the world of turbines in the path of flowing water runway for hydro power generation activity to supply the majority generated electricity to the power grid and use a limited amount of the total generated electricity for pumping there by the pumps pump water continuously inside the pipe and the inter connected net work of pipelines can supply drinking water for long distances to all people living in a specified area or city and pump away the human utilized waste water flowing into the sewerage multiple inter connected pipe lines and industrial waste water flowing into multiple inter connected pipe lines networks to sewerage treatment plants all the year round will be used for power generation because of the available kinetic energy combined with the hard pressure running inside the pipe, tunnel, man made structures it will be apparent to those skilled in the art that other changes in form and detail may be made therein without departing from the spirit and scope of the invention.
15. Those of skill in the art will appreciate This innovation is for power generation using various forms and branches using any water body or any water or any other suitable required raw material like water, fluids, wind, air, etc inside the area of power generation sector with the application of using the Pipe, tunnel and other man made structures to support hydro power generation power plants or hybrid hydro power generation power plants in combinations of various other hybrid power generation power plants too Using the application of the pipe, tunnel, any man made structure is in the scope of the invention it will be apparent to those skilled in the art that other changes in form and detail may be made therein without departing from the spirit and scope of the invention
16. Those of skill in the art will appreciate The application is water or fluid to run, fall, flow, or store or vice verse or any other arrangement of the flow pattern desired and used to design a individual power generation power plant or using the union and working combination of one or more methods from the area of hydro power generation like the run of the river generation with the union and working combination of dam generation for designing hybrid hydro power generation power plant for power generation and for various other activities to support the innovation or pump storage generation with the union and working combination of run of the river generation for designing hybrid hydro power generation power plant for power generation or dam generation with the union and working combination of run of the river generation and pump storage generation for designing hybrid hydro power generation power plant for power generation will be designed in the earth, on the earth, or on top of the earth by using a pipe, tunnel, any man made structures it will be apparent to those skilled in the art that other changes in form and detail may be made therein without departing from the spirit and scope of the invention
17. Those of skill in the art will appreciate In working combination with cascading hydro power generation power plant technology union by using lift irrigation technology laws for sending water by using pumps for sending irrigation water or sending municipal water for long distances in drinking water pipe lines network or irrigation pipeline networks there by generating electricity from the kinetic energy released by the help of the pumps for pumping water is associated with the union and combination of the hard pressure released thereby inside the pipe, tunnel or man made structures by placing generator-turbine and turbine blades connected to the shaft in the path of flowing water or fluid to generate electricity it will be apparent to those skilled in the art that other changes in form and detail may be made therein without departing from the spirit and scope of the invention
18. Those of skill in the art will appreciate Cascading hydro power generation union with working combination with industrial water pipe lines having kinetic energy used for designing hydro power generation power plant inside the pipe to generate grid connected electricity it will be apparent to those skilled in the art that other changes in form and detail may be made therein without departing from the spirit and scope of the invention.
19. Those of skill in the art will appreciate Cascading hydro power generation with waste water pipe lines and sewerage canals for hydro power generation power plants inside the pipes to generate grid connected electricity, it will be apparent to those skilled in the art that other changes in form and detail may be made therein without departing from the spirit and scope of the invention.
20. Those of skill in the art will appreciate Multiple cascading electrical generation systems inside the land and above the land or two way design cascading electrical generation system one cascading electrical generation system above the ground or top of the earth with the union and working combination of another individual cascading electrical generation system below the ground in a individual embodiment to generate electricity or multiple directional cascading electrical generation systems union with working combination of any hybrid power generation power plant for electrical generation or with the various unions and combination, designs, technologies, using various engineering, architectural, geometrical degrees, angles and designs in association to design hybrid power plant generation or non hybrid power plant generation is for the innovation of new hybrid power generation power plants in the pipe or tunnel or man made structures it will be apparent to those skilled in the art that other changes in form and detail may be made therein without departing from the spirit and scope of the invention.
21. Those of skill in the art will appreciate Using the combination of every technology for individual projects supporting individual generation requirements globally using pipe or tunnel or any man made structure by using the natural level differences or man made level differences found in between the water body and the surrounding earth for hydro power generation because water flows from a higher level to a lower level for the discharge of the kinetic energy which is used for power generation there by it will be apparent to those skilled in the art that other changes in form and detail may be made therein without departing from the spirit and scope of the invention.
22. Those of skill in the art will appreciate Using different diameters of pipe ranging from at least from few inches to at least 200 meters in diameter or more, with inter connected pipes line net work running into few thousand square miles inside the earth or on top of the earth surrounding a city or a human dwelling and going to a depth inside the earth for placing of the inter connected pipe line net work from at least 0 meters or surface of the earth to at least 600 meters deep under the earth for the running water inside the pipe, tunnel, any man made structure to help in hydro power generation, it will be apparent to those skilled in the art that other changes in form and detail may be made therein without departing from the spirit and scope of the invention.
23. Those of skill in the art will appreciate By the usage of all the different electrical generation equipments for used for power generation placed in there respective fields or areas like the pipes, tunnels or in any man made structures using all the hydraulic laws, fluid dynamic laws or with the universally used generation laws for various power generations technologies and applying all safety measures for every generation technology are implemented in this innovation it will be apparent to those skilled in the art that other changes in form and detail may be made therein without departing from the spirit and scope of the invention.
24. Those of skill in the art will appreciate With the application like turbine and turbine blades connected to a shaft placed in the path of flowing water, running water, falling water or using wind, air or any other suitable matter inside the pipe, tunnel and other man made structures designed according to the defined usage or specific application to the areas of electrical generation it will be apparent to those skilled in the art that other changes in form and detail may be made therein without departing from the spirit and scope of the invention.
25. Those of skill in the art will appreciate Generator placed on the dry area on top of the pipe, tunnel and in any man made structures on the upper layer for power generation it will be apparent to those skilled in the art that other changes in form and detail may be made therein without departing from the spirit and scope of the invention.
26. Those of skill in the art will appreciate Using submersible Generator submerged in the water inside the pipe, tunnel and in any man made structures in the water runways on the lower layer to generate hydro electricity or to generate hybrid hydro electrical generation it will be apparent to those skilled in the art that other changes in form and detail may be made therein without departing from the spirit and scope of the invention.
27. Those of skill in the art will appreciate The generated electricity is transmitted to the grid or personally used for pumping and other maintenance of the power plant working with union of lift irrigation laws or for multiple uses to support the innovation in other areas to develop like using excess water pumped out for eco tourism, excess pumped out water for prawn and fish farming, excess pump out salt water for desalination plants or other relevant usages or purchase electricity from the grid or used for storing, it will be apparent to those skilled in the art that other changes in form and detail may be made therein without departing from the spirit and scope of the invention.
28. Those of skill in the art will appreciate To support the innovation to design new power generation power plants using pipe, tunnel or any man made structures and technology which is not limited to the method or claims or in detail with hydro power generation, all varieties of different working combinations of hybrid power plant generation, construction, fabrication, material application or uses described herein, Indeed any suitable variation of hydro power generation, hybrid hydro power plant generation or any variety of hybrid power plant generation designing, fabrication, use or application is contemplated as an alternative embodiment it will be apparent to those skilled in the art that other changes in form and detail may be made therein without departing from the spirit and scope of the invention.
29. Those of skill in the art will appreciate It is further intended that any other embodiments of the present invention that result from any changes in application, design or method of use or operation, configuration with hydro power generation or with various hybrid power plant generation technology by using various hybrid power generation power plants combinations and working unions supporting for the usage of any raw material or the manufacturing of various power generation equipments used for various different power generation technologies used to support various hybrid power generation power plants and renewable energy power generation power plants or hydro power generation power plants shape, size or material used which are not specified within the detailed written description or illustrations contained herein for power generation It will be apparent to those skilled in the art that other changes in form and detail may be made therein without departing from the spirit and scope of the invention.
30. Those of skill in the art will appreciate As defined in all of the appended method and claims and there by the innovation in total for using the pipe, digging tunnel or construction of any other man made structures for hydro power generation or any hybrid power plant generation development and for all other business related matters for using Pipe, tunnel, any man made structure to support the innovation revolving around the usage of the invention will use every technology jointly and severally what so ever for the benefit of the above described innovation in its various forms, branches and description what so ever described here in by using various methods, designs, combinations, technologies, additions, modifications, corrections, manipulations etc it will be apparent to those skilled in the art that other changes in form and detail may be made therein without departing from the spirit and scope of the invention.
31. Those of skill in the art will appreciate Taking the help from various engineering departments inputs for designing various different hybrid and non hybrid power plants with using various geometrical figures, angles and degrees suitable for an individual power project and for individual site to generate electricity from few watts, small, medium and big generations “head varies and the generation varies”. The innovation will be inside the earth, outside the earth or on the surface of the earth and above the earth or inside the water body or on the water body or above the water body, according to the individual generation requirements of every individual power project suitable for a individual site is designed by using this innovation is tailor made to suit every individual power generation requirements globally for every country independently is for the overall development of industry and human beings as a single unit it will be apparent to those skilled in the art that other changes in form and detail may be made therein without departing from the spirit and scope of the invention.
32. Those of skill in the art will appreciate For example: using a pipe for hydro power generation of at least 6 inches in diameter with water flowing velocity at the rate of at least 4 meters per second by using at least 12 volts or 24 volts or more voltage dynamos or Archimedes screw turbine design or using axel flow turbine design or using Davis hydro turbine design or any different models used for Tidal power generation in this the shaft is fixed to the pipe and the generator fixed on top of the pipe, the shaft is attached by at least 4 or more hydro foil blades there by water running inside the pipe having kinetic energy combined with hard pressure will keep on spinning and rotating the blades attached to the shaft and spinning of the shaft will spin the rotor in the variable speed electrical generator assembly there by generating electricity or using the tidal fence turbine design or using many newly developed turbines designs for the tidal and barrier flows or any suitable turbine design for the maximum low head using run of the river generation turbine design to get fixed inside to the pipe will be p=head 6 inches or 9 centimeters or 0.009 meters×flow 20 liters per second or 0.02 cubic meters per second passing through the turbine blades at the rate of 2 meters per second is the water velocity to spin the turbine blades connected to the shaft×gravity 9.81×efficiency at least 40% is maximum output=0.001 KWH of power generated per hour from using just one machine or one baby micro-turbine or if we are using 5 diameters missile shape pipe “inlet 5 diameters body 30 meters long and outlet 1 diameter” then P=Head 5 meters×Flow 12 cubic meters per second×Gravity 9.81×Efficiency just 40%=235.4 KWH and kindly calculate from the inter connected pipeline waterways of a city or in a country as a single individual unit using calculated spacing in between each turbine placement using cascading arrangement to fix generator-turbine in rows or series or one after another in pipe, tunnel, man made structures there by increasing in the total generation output into billions of Mega Watts clean and green electricity because more machinery is used in the interconnected pipe line network for power generation there by increase in the generation out put there by this improvement in power generation will help reduce using fossil fuels and oil, eradicate poverty and help improve literacy and also help to develop greens in and round the country in the long run. This is only an example so by using Just 6 inches, 12 inches, 24, inches, 48 inches, 60 inches or more bigger pipes because different diameter pipe lines are running into few hundred square miles network in a given human dwelling like the city so that the generated electricity will be connected into many small local grids to distribute the generated electricity in the same local colonies where the inter connected water pipelines run there by generation and transmission in a limited small area using just that little areas interconnected pipe network for local power generation will support the concept of small grid is smart grid development it will be apparent to those skilled in the art that other changes in form and detail may be made therein without departing from the spirit and scope of the invention.
33. Those of skill in the art will appreciate Kindly note “head varies generation varies” as the pipe diameter is increasing from at least few inches, 6 inches, 12 inches, 24 inches, 48 inches or more or using the standard measurements for designing pipes for different water applications and also tailor made designs ranging from at least 3 diameters pipe to at least 200 diameters pipe, it will be apparent to those skilled in the art that other changes in form and detail may be made therein without departing from the spirit and scope of the invention.
34. Those of skill in the art will appreciate If the innovation is using 5 diameters missile shape pipe “inlet 5 diameters body 30 meters long and outlet 2 diameter” then p=head 5 meters×flow 12 cubic meters per second×gravity 9.81×efficiency just 40% only=235.4 KWH of electricity is generated every hour from just using only one individual pipe Or If the innovation using 20 diameter missile shape pipe “inlet 20 diameters body 150 meters long and outlet 4 diameters” then p=head 20 meters×flow 20 cubic meters per second×gravity 9.81×efficiency just 40% only=1569.6 KWH of electricity is generated every hour from just using only one individual pipe, or By placing series of pipes one after another fixed on a flyover type ramp supported by pillars constructed opposite the ocean and near to the beach or on the beach itself slantingly sloppily down for at least 100 kilometers distance and each pipe of at least 150 diameters inlet, pipe body distance will be at least 2000 meters long and pipe outlet at least 40 diameters. In this 150 diameter pipe inlet will be receiving water coming continuously from using at least 5000 pump turbines of at least 415 Megawatts each (415 MW pump turbine can pump in single stage for 800 meters vertically up, we use this pressure in horizontal pipeline network for the release of kinetic energy in pipes), All 5000 pump turbines will be erected just opposite the beach in horizontal arrangement one after another and opposite the ocean and parallel to the beach at least few meters away from the beach on the land and each 415 MW pump turbine outlet discharge pipe outflows will be directly connected to a common supply pipe of at least 50 diameters placed just opposite of the 5000 individual pump turbines horizontally and with each pump turbine pumping at least 20 cubic meters of water per second per minute pumped inside the 50 diameters pipe connected to the master reservoir p1 because of the horizontal arrangement of the pipe just opposite the 5000 individual pump turbines, pumped out water flows continuously all the time inside the 150 diameters pipe every second. Water is pumped from the ocean into the 50-diameter pipe at the rate of 96000 cubic meters of water per second using 5000 pump turbines. At least A 1000 MW generator-turbine is placed outside of the 40 diameter pipe outlet on the path of flowing water (inlet: 150 diameters, body of the pipe 2000 meters long and outlet 40 diameters, missile shape Pipe) in the path of flowing water, p=head 150 meters×flow 96000 cubic meters water per second×gravity 9.81×efficiency just 40%=56505600 KWH of power generated from just one pipe and on the 100 kilometers long flyover there will be 20 independent pipes (inlet:150 diameters, body of the pipe 2000 meters long and outlet 40 diameters) connected with each other, 1^{st} pipe: the inlet of the pipe 150 diameters and body of the pipe 2000 meters long and outlet of the pipe 40 diameters connected again to the 2^{nd} pipe: inlet of the pipe 150 diameters and body of the pipe 2000 meters long and outlet of the pipe 40 diameters, like this one full pipe after another full pipe and with this missile type pipe design will generate the required kinetic energy, hard pressure inside the pipe for the 1000 MW generator-turbine to generate electricity when water is released 96000 cubic meters per second per minute all from the 40 diameters outlet valve or gate for the water pressure head 96000 cubic meters of water per second to rotate inside the turbine blades connected to the shaft and shaft connected to the generator to generate electricity so the 20 independent pipes placed one after another having individual 20 power houses, for each pipe outlet one power house having a generator-turbine just outside the 40 diameter pipe outlet on the path of the flowing water of each pipe will generate collectively 1,13,01,12,000 KWH of electricity every one hour. (56505600 KWH generated per each pipe×20 individual pipes will be =1,13,01,12,000 KWH per hour generation) and for pump consumption the 5000 individual pump turbines of 415 MW each will consume collectively 70,00,00,000 KWH of electricity per one hour or 140,000 KWH per each individual 415 MW pump turbine per every one hour to pump at least 20 cubic meters per second collectively 96000 cubic meters of water every second per minute inside the 150 diameter pipe or called as the p1 master reservoir having 50 diameters and this master reservoir is directly connected to the cascading arrangement of 20 pipes will be having a man made gradient and will be arranged slantingly sloppily down one pipe after another pipe and each individual pipe will have a individual power house and at least one turbine fixed inside the pipe and all 20 individual pipes fixed on the flyover type ramp 100 kilometers long for the water to flow down from one individual pipe to another pipe by the law of gravity. As this entire structure is near the beach water discharged from the last turbine tail release will fall inside the water body there by no pollution of water released near the beach area because the water enters from p1 master reservoir 96000 cubic meters per second will flow down from the very first power house p1 to the very last power house p20 there by just one second water called the p1 power house i.e. 96000 cubic meters of water per second only flows down from p1 turbine to p20 turbine and the final p20th turbine tail release water 96000 cubic meters per second only flows out of the out let situated at the far end of the ramp or at the bottom side of the ramp at the 100th kilometer will flow out and fall inside the water body because of only one inlet and only one outlet for the water to enter and exit of the system designed. The pipe or pipes are designed in the shape of a missile like inlet big and outlet small “missile shape pipe” and the body of the pipe having arrangements or openings for fixing the turbine or multiple turbines in rows or series at specified pin point intervals, All pipes are arranged in cascading design one pipe after another pipe in various required gradients and angles for using various water applications by using various standard materials like cement pipes, iron pipes, plastic pipes, fiberglass pipes, tailor made pre fabricated pipes or for that reason any material is used to make the pipe for a given individual project is tailor made by taking the various amount of hard pressure built inside the pipe and by the volume of the mass of water flowing inside the pipe every second and the flow rate of water from at least few inches to meters with various velocity pattern of the water flow like low head, medium head, high head is also increasing in the pipe there by the grid connectivity power generation output will also be increasing simultaneously to support the peak load demands of the grid all the year round, it will be apparent to those skilled in the art that other changes in form and detail may be made therein without departing from the spirit and scope of the invention.
35. Those of skill in the art will appreciate this invention and method by the above specified within the detailed written description or illustrations contained herein, Accordingly while the present invention has been shown and described with reference to the foregoing embodiments of the invented technology as defined in all of The appended method and claims and there by using the pipe for hydro power generation or generating hydro power generation inside the pipe or tunnel as a new method or innovation to be added in the world of hydro power generation for generating the cheapest grid connecting electricity because no purchase of raw material and transportation cost of the raw material to the site is also nil, in total this is the method it will be apparent to those skilled in the art that other changes in form and detail may be made therein without departing from the spirit and scope of the invention.

2: Hydrogen Corporation and Electrical bunks Union for electrical generation to support hybrid vehicles battery charging stations.
(1) Those of skill in the art will appreciate Hydrogen Corporation and Electrical bunks union placed at various comfortable locations on the highways or in other suitable places like factories or areas of every country in combination and working union or for working with other hybrid and non hybrid power plants union and with this made for each other support and combination with the working union is designed for the combination of hybrid electrical generation power plants to generate electricity to support the grid in peak load requirements and to support the fueling stations designed for charging all different hybrid electrical vehicles and all locomotives used in area of transportation services running on electricity charged battery's or running by using electricity or for any multiple uses to support the industry there by it will be apparent to those skilled in the art that other changes in form and detail may be made therein without departing from the spirit and scope of the invention.

3: Hybrid generation and ordinary generation union and combination for the hybrid electricity generation.
(1) Those of skill in the art will appreciate Hybrid generation and ordinary generation or fossil fuel generation clubbed working union or the working combination of both areas to support various fossil fuel electrical generation power plants with the working union and combination of various renewable energy electrical generation power plants combinations, vice verse for the support of different inter related various hybrid electrical power generation power plants for the generation of the electricity and to transmit the generated electrical generation connected into the grid for the overall development of the peak load demand of industry and mankind as a single unit there by it will be apparent to those skilled in the art that other changes in form and detail may be made therein without departing from the spirit and scope of the invention.

4: Cascading marine and hydro electrical generation for emergency peak load transmission to balance the grid.
(1) Those of skill in the art will appreciate All Water Bodies and land on the planet used for cascading marine and hydro electrical generation or to develop hybrid electrical power generation or non hybrid electrical power generation in every country as per only our invention, method and laws as per the method described herein will use Pipe, tunnel, tube, intakes, canal, channel, ducts, spillways, weirs, or any other types of systems, methods, water ways, water bodies wherein water or a fluid can flow, run, fall or be stored or vice verse inside the man made structures. It can always be substituted by any other type or types of water bodies and no limitation as to any varieties of water ways, water bodies, systems, methods available globally for hydro power generation, hybrid hydro power generation or various hybrid power plant generations and the design and method above described will be used for all types of water ways must be read in the specification for the purpose of hydro power generation or with a combination of hybrid hydro power generation or hybrid electrical generation associated with the innovation for the generation of electricity to support the industry and man kind globally, it will be apparent to those skilled in the art that other changes in form and detail may be made therein without departing from the spirit and scope of the invention.

5: Carbon Credits to develop forests to support hydro power generation.
(1) Those of skill in the art will appreciate Carbon Credits generated by using this method to reduce global warming and pollution will be used only to generate clean and green electricity and to develop greenery of the country by developing forests to support hydro power generation it will be apparent to those skilled in the art that other changes in form and detail may be made therein without departing from the spirit and scope of the invention.

6: Hybrid power plants union for hydro power generation
(1) Those of skill in the art will appreciate Combination of every engineering department inputs for designing hybrid generation power plants using industrial hydraulics or pneumatic laws to circulate the water from the inlet to the outlet and to lift water from bottom to top in the earth and above the mean sea level for the generation of electricity using the pipe and in the pipe, in the tunnel and in all such man made structures to generate hydro electricity or hybrid hydro electricity for the development of the industry and man kind there by it will be apparent to those skilled in the art that other changes in form and detail may be made therein without departing from the spirit and scope of the invention.

7: Using pipe in a closed area or open area for hydro power generation facility
(1) Those of skill in the art will appreciate The facility or innovation can be in a closed area or open area to generate electricity by using pipe, tunnel and any other man made structures for hydro power generation and hybrid cascading hydro power generation, it will be apparent to those skilled in the art that other changes in form and detail may be made therein without departing from the spirit and scope of the invention.

8: Using Pipe in the water body, on the water body and out of water body for hydro power generation facility
(1) Those of skill in the art will appreciate The facility or the innovation can be in the water body, on the water body and out of water body to generate electricity using pipe, tunnel and other man made structures for hydro power generation and hybrid hydro power generation, it will be apparent to those skilled in the art that other changes in form and detail may be made therein without departing from the spirit and scope of the invention.

9: Using Pipe inside the earth, on the earth and top of the earth for hydro power generation facility
(1) Those of skill in the art will appreciate The facility or innovation can be inside the earth, on the earth and outside the earth or top of the earth to generate electricity using pipe, tunnel and other man made structures to generate hydro electricity and or to design hybrid hydro power generation power plant for power generation it will be apparent to those skilled in the art that other changes in form and detail may be made therein without departing from the spirit and scope of the invention.

10: Combination of Different technologies union in side the pipe or tunnel for hydro power generation.
(1) Those of skill in the art will appreciate This method of electrical generation innovation using pipe, tunnel, any man made structure is for the combination of application in various hydro power generation technologies to form a individual hybrid hydro electrical generation power plant inside a pipe, tunnel or inside any man made structures and with the application of water or fluid as the raw material will use every technology jointly and severally what so ever for the benefit of the innovation in its various forms, branches and description what so ever described here in by using various methods, designs, combinations, technologies from the world of hydro power generation engineering or using our personal invented technologies method and claims to support for working combinations with the present innovation, like additions, modifications, corrections, manipulations, hybrids in the field of electrical generation by placing any turbine and turbine blades having any shape, size, model, design, angle or from the world of turbines available in various countries and designers or manufactures and turbine blades of any size, shape, thickness including any exact curvature of the blades or angle of the blades for absorbing the kinetic energy running inside the pipe for power generation and using any material or alloy for manufacturing the blades of the turbine there by only this type of a suitable turbine is connected to the shaft in the area of usage like the pipe, tunnel and any man made structures etc designed in various engineering, architectural, geometrical figures, angles and degrees suitable for an individual project and individual site for placing the pipe, tunnel, any man made structure, flow of the water, fluid, wind, air or any matter or raw material to circulate inside the turbine and to impinge the turbine blades to generate electricity using pipe, tunnel, channel or any other man made structure for electrical generation and for designing hybrid electrical generation power plants with the working union from the world of fossil fuels power plants union and combining with the world of every renewable energy working power plants joint efforts for various interrelated hybrid electrical generation power plants used for grid connected generating electricity for domestic and industrial use for the development of the man kind as a single unit it will be apparent to those skilled in the art that other changes in form and detail may be made therein without departing from the spirit and scope of the invention.
